(19) United States
(12) Patent Application Publication
(10) Pub. No.: US 2001/0028338 A1
(43) Pub. Date: Oct. 11, 2001

(54) Liquid crystal display device

(76) Inventors: Manabu Kayamori, Yokohama-shi (JP); Koutarou Hirai, Yokohama-shi (JP)

Correspondence Address: PEARNE & GORDON LLP, 526 SUPERIOR AVENUE EAST, SUITE 1200, CLEVELAND, OH, 44114-1484, US

(21) Appl. No.: 09/794,418

(22) Filed: Feb. 27, 2001

(30) Foreign Application Priority Data
Feb. 29, 2000 (JP) P. 2000-54913

(51) Int. Cl. G09G 3/36

(52) U.S. Cl. 345/101

(57) ABSTRACT

Temperature measuring unit measures an ambient temperature and outputs a measurement result to control unit. The control unit outputs information for optimally setting the number of boosting stages of boosting unit as a control signal to driving circuit. Upon receipt of the control signal, the driving circuit stores the information in storage unit, sets the number of boosting stages of the boosting unit according to the information stored in the storage unit, and supplies a driving voltage to liquid crystal display unit. If the ambient temperature is changed, the number of boosting stages of the boosting unit is reset in the procedure so that the consumed current of the whole liquid crystal display device can be optimized.

### BACKGROUND OF THE INVENTION

The present invention relates to a liquid crystal display device for displaying a character and an image, and more particularly to a liquid crystal display device for regulating a liquid crystal driving voltage depending on an ambient temperature.

FIG. 5 shows the structure of a conventional liquid crystal display device. The liquid crystal display device is constituted by a liquid crystal display unit 1 for displaying a character and an image, a driving circuit 2 for supplying a driving voltage 21 to the liquid crystal display unit 1, and a control unit 3 for outputting a control signal 31 to control the driving circuit 2. Moreover, the driving circuit 2 is constituted by a storage unit 23 for storing information of the control signal 31, and a boosting unit 22 capable of setting the number of boosting stages corresponding to the information stored in the storage unit 23.

Next, the operation of the liquid crystal display device will be described. First of all, when a power supply is turned ON, information for outputting, as the control signal 31, the optimum driving voltage 21 to the liquid crystal display unit 1 for initial setting from the control unit 3 to the driving circuit 2. Then, the driving circuit 2 receiving the control signal 31 stores the information in the storage unit 23 and sets the number of boosting stages of the boosting unit 22, thereby outputting the optimum driving voltage 21 to the liquid crystal display unit.

In general, the information stored in the storage unit 23 always has the same contents while the liquid crystal display device is operated, and is not changed before the power supply of the liquid crystal display device is turned OFF. Therefore, the driving voltage 21 output from the boosting unit 22 is always set to be constant. In other words, in a conventional general liquid crystal display device, the number of boosting stages of the boosting unit is not changed during the subsequent operation after the number of boosting stages is set for the initial setting when the power supply is turned ON. The information provides the number of boosting stages supposing the time of a low temperature at which the number of boosting stages is most required.

In the conventional liquid crystal display device, however, the number of boosting stages is determined by supposing the time of a low temperature at which the number of boosting stages is most required. Therefore, a driving voltage is supplied with the number of boosting stages which is more than necessary at an ordinary temperature and a high temperature. The consumed current of the driving circuit is proportional to the number of boosting stages. If the number of boosting stages is increased, the consumed current is also increased. If the number of boosting stages is decreased, the consumed current is also reduced. Therefore, the conventional liquid crystal display device has had a problem in that the consumed current of the whole liquid crystal display device is increased with the number of boosting stages which is more than necessary.

### SUMMARY OF THE INVENTION

In order to solve the conventional problems, it is an object of the invention to provide an excellent liquid crystal display device for controlling driving circuit depending on an ambient temperature, thereby optimizing the consumed current of the whole liquid crystal display device.

The invention provides a liquid crystal display device comprising a liquid crystal display unit, a driving circuit for supplying a driving voltage to the liquid crystal display unit, a temperature measuring unit for measuring an ambient temperature, and a control unit for controlling the driving voltage depending on a measurement result of the temperature measuring unit. With such a structure, the driving voltage for driving the liquid crystal display unit is changed depending on the ambient temperature so that the consumed current of the whole liquid crystal display device can be optimized.

### BRIEF DESCRIPTION OF THE DRAWINGS

FIG. 1 is a block diagram showing a liquid crystal display device according to a first embodiment of the invention;

FIG. 2 is a diagram showing an example of the relationship of correspondence of the number of boosting stages to an ambient temperature according to the first embodiment of the invention;

FIG. 3 is a block diagram showing a liquid crystal display device according to a second embodiment of the invention;

FIG. 4 is a diagram showing an example of relationship of correspondence of the number of boosting stages and switching unit to be turned ON to an ambient temperature according to the second embodiment of the invention; and

FIG. 5 is a block diagram showing a conventional liquid crystal display device.

### DETAILED DESCRIPTION OF THE PREFERRED EMBODIMENT

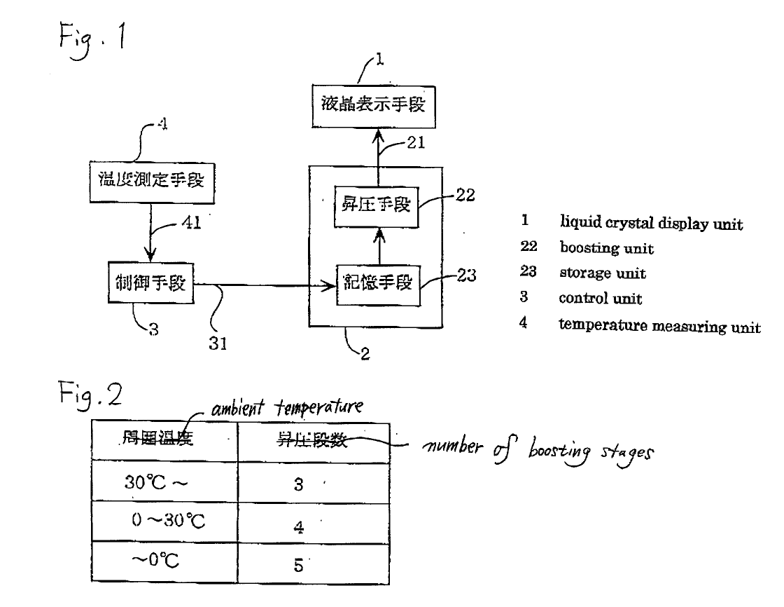

Embodiments of the invention will be described below with reference to FIGS. 1 to 4.

### Embodiment 1

FIG. 1 is a block diagram showing a liquid crystal display device according to a first embodiment of the invention. The liquid crystal display device comprises a liquid crystal display unit 1 for displaying a character and an image, a driving circuit 2 for supplying a driving voltage 21 to the liquid crystal display unit 1, a control unit 3 for outputting a control signal 31 to control the driving circuit 2, and a temperature measuring unit 4 for measuring an ambient temperature to output a measurement result 41 to the control unit 3. The driving circuit 2 is constituted by a storage unit 23 for storing the control signal 31 output from the control unit 3, and a boosting unit 22 for changing the number of boosting stages according to information stored in the storage unit 23.

The operation of the liquid crystal display device having such a structure will be described with reference to FIGS. 1 and 2. First of all, an ambient temperature is measured by the temperature measuring unit 4, and a result of the measurement is output as the measurement result 41 to the control unit 3. Te control unit 3 outputs information for optimally setting the number of boosting stages of the boosting unit 22 as the control signal 31 to the driving circuit 2 according to the measurement result 41.

FIG. 2 shows an example of the relationship of correspondence of the number of boosting stages to an ambient temperature. As shown in FIG. 2, the control unit 3 sets: (1) the number of boosting stages to three if the ambient temperature is30° C. or higher; (2) the number of boosting stages to four if the ambient temperature is 0° C. to 30° C., and (3) the number of boosting stages to five if the ambient temperature is 0° C. or lower Accordingly, when the ambient temperature is 25° C., for example, the control unit 3 receives the measurement result 41 and outputs, to the driving circuit 2, the control signal 31 for setting the number of boosting stages of the boosting unit 22 of the driving circuit 2 to four. The driving circuit 2 receiving the control signal. 31 stores the information in the storage unit 23, sets the number of boosting stages of the boosting unit 22 to four depending on the information stared in the storage unit 23 and supplies the driving voltage 21 to the liquid crystal display unit 1. When the ambient temperature is changed, the number of boosting stages of the boosting unit 22 is reset in the procedure described above so that the consumed current of the whole liquid crystal display device can be optimized. While the number of boosting stages to be changed depending on the ambient temperature has been three, the same procedure can be carried out for two stages and four stages according to the temperature characteristic of the liquid crystal display unit.

### Second Embodiment

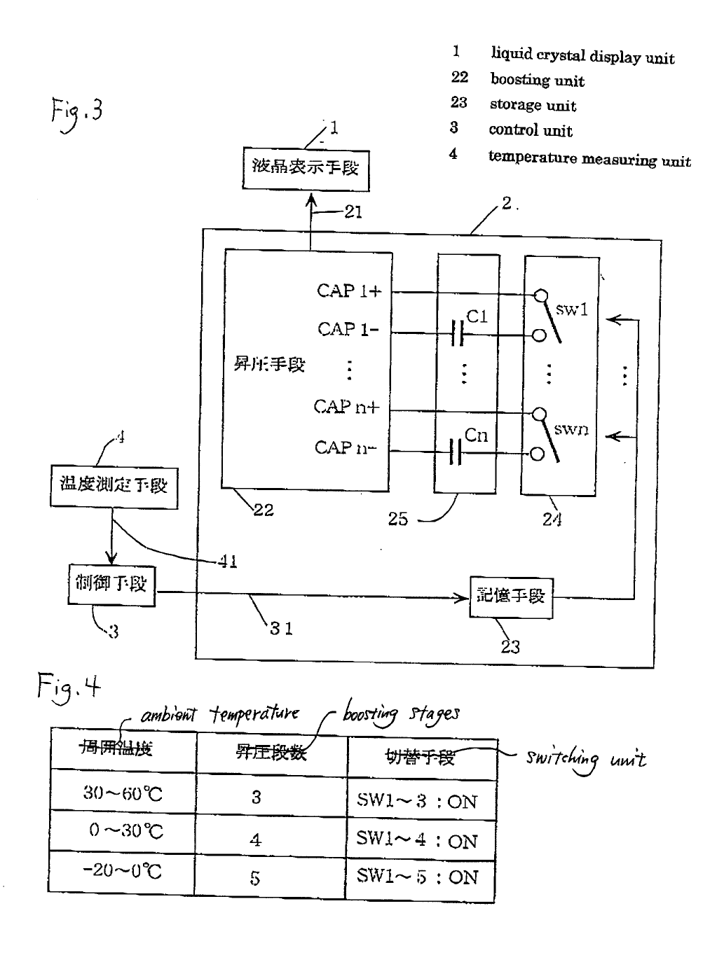

FIG. 3 is a block diagram showing a liquid crystal display device according to a second embodiment of the invention. The liquid crystal display device comprises a liquid crystal display unit 1 for displaying a character and an image, a driving circuit 2 for supplying a driving voltage 21 to the liquid crystal display unit 1, a control unit 3 for outputting a control signal 31 to control the driving circuit 2, and a temperature measuring unit 4 for measuring an ambient temperature to output a measurement result 41 to the control unit 3. The driving circuit 2 is constituted by a storage unit 23 for storing the control signal 31 output from the control unit 3, a boosting capacitor group 25 having at least two capacitors for boosting, a switching unit 24 for switching the number of stages of the boosting capacitor group 25 according to the information stored in the storage unit 23, and a boosting unit 22 for changing the number of boosting stages according to the operation of the switching unit 24. Furthermore, the boosting capacitor group 25 is constituted by n capacitors for boosting 25₁ to 25ₙ and the switching unit 24 is constituted by n switches 24₁ to 24ₙ. The switch 24₁ serves to carry out ON/OFF control of the capacitor for boosting 25₁ and the switch 24, serves to carry out ON/OFF control of the capacitor for boosting 25ₙ.

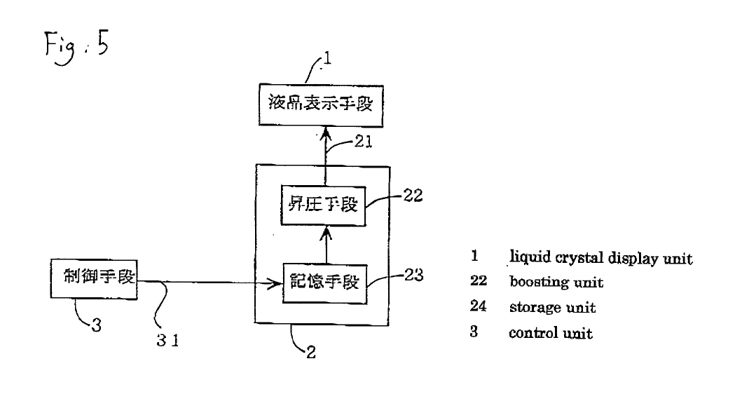

The operation of the liquid crystal display device having such a structure will be described with reference to FIGS. 3 and 4. First of all, an ambient temperature is measured by the temperature measuring unit 4, and a result of the measurement is output as the measurement result 41 to the control unit 3. The control unit 3 outputs information for optimally setting the number of boosting stages of the boosting unit 22 as the control signal 31 to the driving circuit 2 according to the measurement result 41.

FIG. 4 shows an example of the relationship of correspondence of the number of boosting stages and the switching unit to be turned ON to an ambient temperature. As shown in FIG. 4, the control unit 3 sets: (1) the number of boosting stages to three if the ambient temperature is 30° C. or higher; (2) the number of boosting stages to four if the ambient temperature is 0° C. to 30° C.; and (3) the number of boosting stages to five if the ambient temperature is 0° C. or lower. Accordingly, when the ambient temperature is 25° C., for example, the control unit 3 receives the measurement result 41 and outputs, to the driving circuit 2, the control signal 31 for controlling the number of boosting stages of the boosting unit 22 to four according to the result. The driving circuit 2 receiving the control signal 31 stores the information in the storage unit 23 and sets four switches 24₁ to 24ₙ (n=4) of the switching unit 24 according to the information stored in the storage unit 23, thereby turning ON four capacitors for boosting 25₁ to 25ₙ (n=4) of the boosting capacitor group 25 and outputting the driving voltage 21 to the liquid crystal display unit 1. If the ambient temperature is changed, the number of the switches 24₁ to 24ₙ of the switching unit 24 to be turned ON in the procedure is reset to be optimum for the temperature, thereby resetting the capacitors for boosting 25₁ to 25ₙ. Consequently, the consumed current of the whole liquid crystal display device can be optimized. While the number of boosting stages to be changed depending on the ambient temperature has been three, the same procedure can also be carried out for two stages and four stages according to the temperature characteristic of the liquid crystal display unit.

As described above, the present invention can provide a liquid crystal display device comprising liquid crystal display unit, driving circuit for supplying a driving voltage to the liquid crystal display unit, temperature measuring unit for measuring an ambient temperature, and control unit for changing the driving voltage depending on a measurement result of the temperature measuring unit, thereby obtaining such an excellent effect that the driving voltage for driving the liquid crystal display unit is changed depending on the ambient temperature so that the consumed current of the whole liquid crystal display device can be optimized.

What is claimed is:

1. A liquid crystal display device comprising:
a liquid crystal display unit;
a driving circuit for supplying a driving voltage to the liquid crystal display unit;
a temperature measuring unit for measuring an ambient temperature; and
a control unit for controlling the driving voltage depending on a measurement result of the temperature measuring unit.

2. A liquid crystal display device according to claim 1, wherein the driving circuit includes:
a storage unit for storing a control signal output from the control unit depending on the measurement result of the temperature measuring unit; and
a boosting unit for changing the driving voltage depending on contents stored in the storage unit.

3. A liquid crystal display device according to claim 1, wherein the driving circuit includes:
a storage unit for storing a control signal output from the control unit depending on the measurement result of the temperature measuring unit;
at least two capacitors for boosting;
a switching unit for switching the number of stages of the capacitors for boosting depending on the contents stored in the storage unit; and
a boosting unit for changing the number of boosting stages depending on an operation of the switching unit.
